(19) United States
(12) Patent Application Publication
(10) Pub. No.: US 2023/0270196 A1
(43) Pub. Date: Aug. 31, 2023

(54) FIBERS FOR ARTIFICIAL HAIR, METHOD FOR PRODUCING SAME, AND HEADDRESS ARTICLE

(71) Applicant: Denka Company Limited, Chuo-ku, Tokyo (JP)

(72) Inventors: Takashi MURAOKA, Chuo-ku, Tokyo (JP); Sho HAKAMADA, Chuo-ku, Tokyo (JP); Atsushi TAKEI, Chuo-ku, Tokyo (JP)

(73) Assignee: Denka Company Limited, Chuo-ku, Tokyo (JP)

(21) Appl. No.: 17/768,964

(22) PCT Filed: Oct. 27, 2020
(86) PCT No.: PCT/JP2020/040299

§ 371 Date: Apr. 14, 2022

(30) Foreign Application Priority Data
Nov. 7, 2019 (JP) 2019-202026
Jul. 28, 2020 (JP) 2020-127218

(51) Int. Cl. A41G 3/00; C08L 77/06; C08L 25/18; A41G 5/00; D01F 6/90; D01F 1/10

(52) U.S. Cl. CPC A41G 3/0083; C08L 77/06; C08L 25/18; A41G 5/004; D01F 6/90; D01F 1/10; C08L 2203/12; C08L 2205/025; C08L 2205/035; C08L 2201/02; D10B 2503/08; D10B 2401/20

(57) ABSTRACT

Disclosed is a fiber for artificial hair, containing a polyamide-based resin and a maleic acid-based polymer having at least one maleic acid compound selected from the group consisting of maleic acid and a maleic acid derivative as a monomer unit. Also disclosed is a headdress article including the fiber for artificial hair. Also disclosed is a method for producing a fiber for artificial hair, the method including a step of spinning a composition containing a polyamide-based resin and a maleic acid-based polymer having at least one maleic acid compound selected from the group consisting of maleic acid and a maleic acid derivative as a monomer unit.

### TECHNICAL FIELD

The present invention relates to a fiber for artificial hair, a method for producing the fiber, a headdress article, and the like.

### BACKGROUND ART

Fibers for artificial hair (fibers used for artificial hair) can be used for hairpieces, hair wigs, false hair, and the like, all of which are wearable on and removable from the head portion. In the following Patent Literature 1, a fiber for artificial hair obtained by fiberizing a resin composition containing a polyamide-based resin and a bromine-based flame retardant is disclosed.

### CITATION LIST

### Patent Literature

Patent Literature 1: Japanese Unexamined Patent Publication No. 2011-246844

### SUMMARY OF INVENTION

### Technical Problem

Since conventional fibers for artificial hair have excessively high luster as compared with human hair, there is a problem that products are easily recognized as artificial hair. Therefore, fibers for artificial hair are required to have less luster.

An object of an aspect of the present invention is to provide a fiber for artificial hair with less luster. An object of another aspect of the present invention is to provide a headdress article including such a fiber for artificial hair. An object of another aspect of the present invention is to provide a method for producing a fiber for artificial hair, the method being capable of obtaining a fiber for artificial hair having, less luster.

### Solution to Problem

An aspect of the present invention relates to a fiber for artificial hair, the fiber containing a polyamide-based resin and a maleic acid-based polymer having, at least one maleic acid compound selected from the group consisting of maleic acid and a maleic acid derivative as a monomer unit.

Another aspect of the present invention relates to a headdress article including the above-mentioned fiber for artificial hair.

Another aspect of the present invention relates to a method for producing a fiber for artificial hair, the method including a step of spinning a composition containing a polyamide-based resin and a maleic acid-based polymer having at least one maleic acid compound selected from the group consisting of maleic acid and a maleic acid derivative as a monomer unit.

### Advantageous Effects of Invention

According to an aspect of the present invention, a fiber for artificial hair with less luster can be provided. According to another aspect of the present invention, a headdress article including such a fiber for artificial hair can be provided. According to another aspect of the present invention, a method for producing a fiber for artificial hair, the method being capable of obtaining a fiber for artificial hair with less luster, can be provided.

### DESCRIPTION OF EMBODIMENTS

Hereinafter, embodiments of the present invention will be described in detail.

The expression “A or more” of a numerical value range means A and a range of more than A. The expression “A or less” of a numerical value range means A and a range of less than A. With regard to a numerical value range described stepwise in the present specification, the upper limit value or the lower limit value of the numerical value range at a certain stage can be optionally combined with the upper limit value or the lower limit value of the numerical value range of another stage. With respect to a numerical value range described in the present specification, the upper limit value or the lower limit value of the numerical value range may be substituted with the values shown in the Examples. The expression “A or B” may include either A or B or may include both of them. Unless particularly stated otherwise, the materials described as examples in the present specification can be used singly or in combination of two or more kinds thereof. In a case where a plurality of substances corresponding to each component in a composition is present, unless particularly stated otherwise, the content of each component in the composition means the total amount of the plurality of substances present in the composition. The term “step” means not only an independent step, but even in a case where a step cannot be clearly distinguished from another step, the step is included in the present term as long as the predetermined action of the step is achieved. The term “(meth)acrylic acid” means at least one of acrylic acid and methacrylic acid corresponding thereto.

A fiber for artificial hair of the present embodiment contains a polyamide-based resin and a maleic acid-based polymer having at least one maleic acid compound selected from the group consisting of maleic acid and a maleic acid derivative as a monomer unit (monomer unit=structural unit; hereinafter, the same). The fiber for artificial hair of the present embodiment can be used as artificial hair and can also be used in order to obtain artificial hair.

The fiber for artificial hair of the present embodiment is a fiber for artificial hair with less luster (degree of luster is 90% or less). In the fiber for artificial hair of the present embodiment, it is speculated that luster is reduced by suitably forming surface unevenness on the surface of the fiber by using the polyimide-based resin and the maleic acid-based polymer in combination. However, the factor in having less luster is not limited to this factor.

Also, according to the fiber for artificial hair of the present embodiment, excellent spinnability can be obtained when unstretched (for example the number of fiber breakages per 200 fibers for artificial hair having a length of 3000 m can be kept at 5 or less). Furthermore, according to the fiber for artificial hair of the present embodiment, excellent combability can also be obtained after a stretching treatment (for example, the resistance force at the time of combing can be kept at 90 gf or less).

The fiber for artificial hair of the present embodiment may be a composition containing the polyamide-based resin and the maleic acid-based polymer or may be formed by a fiber obtained by melt-deforming this resin composition. The fiber for artificial hair of the present embodiment may be a fiber after a stretching treatment or may be an unstretched fiber. Regarding each of the polyamide-based resin and the maleic acid-based polymer, one kind thereof can be used singly, or two or more kinds thereof can be used in combination.

The single fiber fineness of the fiber for artificial hair of the present embodiment is preferably in the following range after a stretching treatment. The single fiber fineness is preferably 20 decitex or more, and more preferably 35 decitex or more. The single fiber fineness is preferably 100 decitex or less, and more preferably 80 decitex or less. From these viewpoints, the single fiber fineness is preferably 20 to 100 decitex, and more preferably 35 to 80 decitex.

From the viewpoint that the stretch ratio can be made small in order to obtain a fiber for artificial hair with a finer fiber degree, and that luster is less likely to be generated in the fiber for artificial hair after a stretching treatment, the single fiber fineness of the fiber for artificial hair of the present embodiment at the time of being unstretched is preferably 300 decitex or less, and more preferably 200 decitex or less.

The polyamide-based resin may be, for example, a polyamide such as an aliphatic polyamide; an aromatic polyamide; or a semi-aromatic polyamide having a skeleton that is obtainable by a polycondensation reaction between an aliphatic diamine and an aromatic dicarboxylic acid. Examples of the aliphatic polyamide include polyamide 6 (nylon 6), polyamide 66 (nylon 66) polyamide 12 (nylon 12), polyamide 6/66 (nylon 6/66), and polyamide 6/12 (nylon 6/12). Examples of the aromatic polyamide include polymetaxylylene-adipamide (nylon MXD6). Examples of the semi-aromatic polyamide include polyamide 6T (nylon 6T), polyamide 9T (nylon 9T), and polyamide 10T (nylon 10T).

The content of the polyamide-based resin is preferably in the following range based on the total mass of the fiber for artificial hair. From the viewpoint that excellent combability is likely to be obtained, the content of the polyamide-based resin is preferably 10% by mass or more, more preferably 20% by mass or more, even more preferably 30% by mass or more, particularly preferably 40% by mass or more, extremely preferably 50% by mass or more, highly preferably more than 50% by mass, even more preferably 60% by mass or more, still more preferably 65% by mass or more, particularly preferably 70% by mass or more, and extremely preferably 75% by mass or more. From the viewpoint that luster is easily reduced, the content of the polyamide-based resin is preferably 95% by mass or less, more preferably 90% by mass or less, even more preferably 80% by mass or less, particularly preferably 75% by mass or less, extremely preferably 70% by mass or less, highly preferably 65% by mass or less, even more preferably 60% by mass or less, still more preferably 50% by mass or less, particularly preferably less than 50% by mass, and extremely preferably 40% by mass or less. From these viewpoints, the content of the polyamide-based resin is preferably 10% to 95% by mass.

The maleic acid-based polymer has at least one maleic acid compound selected from the group consisting of maleic acid and a maleic acid derivative as a monomer unit and can have, a monomer unit derived from a maleic acid compound. Examples of the maleic acid derivative include maleic anhydride, a maleic acid salt (for example, sodium maleate), and a maleic acid ester (for example, a maleic acid alkyl ester such as methyl maleate). From the viewpoint that luster is easily reduced, and from the viewpoint that excellent combability is easily obtained, it is preferable that the maleic acid compound includes maleic anhydride.

It is preferable that the content of the monomer unit of the maleic acid compound in the maleic acid-based polymer is in the following range based on the total mass of the maleic acid-based polymer. From the viewpoint that luster is easily reduced, and from the viewpoint that excellent combability and spinnability are easily obtained, the content of the monomer unit of the maleic acid compound is preferably 0.1% by mass or more, more preferably 0.3% by mass or more, and even more preferably 0.5% by mass or more. From the viewpoint that luster is easily reduced, and from the viewpoint that excellent combability is easily obtained, the content of the monomer unit of the maleic acid compound is preferably 10% by mass or less, more preferably 8% by mass or less, even more preferably 5% by mass or less, particularly preferably 3% by mass or less, extremely preferably 2% by mass or less, and highly preferably 1.5% by mass or less. From these viewpoints, the content of the monomer unit of the maleic acid compound is preferably 0.1% to 10% by mass. From the viewpoint that more excellent combability and spinnability are easily obtained, the content of the monomer unit of the maleic acid compound is preferably 0.8% by mass or more, more preferably 1% by mass or more, even more preferably 1.2% by mass or more, and particularly preferably 1.5% by mass or more. From the viewpoint that luster is more easily reduced, the content of the monomer unit of the maleic acid compound is preferably 1.2% by mass or less, more preferably 1% by mass or less, even more preferably 0.8% by mass or less, and particularly preferably 0.5% by mass or less. The content of the monomer unit of the maleic acid compound in the maleic acid-based polymer can be measured by, for example, a titration method. From a similar viewpoint, it is preferable that the content of the monomer unit of maleic anhydride in the maleic acid-based polymer is in each of these ranges based on the total mass of the maleic acid-based polymer.

The maleic acid-based polymer may have a compound different from the maleic acid compound as a monomer unit and can have a monomer unit derived from a compound different from the maleic acid compound. Examples of the compound different from the maleic acid compound include an aromatic vinyl compound, a maleimide compound, an olefin-based hydrocarbon (ethylene, propylene, butylene, or the like), a (meth)acrylic acid ester (methyl (meth)acrylate, ethyl (meth)acrylate, butyl (meth)acrylate, or the like), an unsaturated dicarboxylic acid (itaconic acid, citraconic acid, aconitic acid, or the like), an unsaturated dicarboxylic acid anhydride (itaconic anhydride, citraconic anhydride, aconitic anhydride, or the like), vinyl acetate, vinylcarboxylic acid ((meth)acrylic acid or the like), and (meth)acrylic acid amide. The maleic acid-based polymer may have a polyalkylene chain (for example, polypropylene chain). From the viewpoint that luster is easily reduced, it is preferable that the maleic acid-based polymer has at least one selected from the group consisting of an aromatic vinyl compound, a maleimide compound, and an olefin-based hydrocarbon as a monomer unit; it is more preferable that the maleic acid-based polymer has at least one selected from the group consisting of an aromatic vinyl compound and a maleimide compound as a monomer unit; and it is even more preferable that the maleic acid-based polymer has an aromatic vinyl compound and a maleimide compound as monomer units.

Examples of the aromatic vinyl compound include styrene-based compounds such as styrene, o-methylstyrene, m-methylstyrene, p-methylstyrene, 2,4-dimethylstyrene, ethylstyrene, p-tert-butylstyrene, α-methylstyrene, and α-methyl-p-methylstyrene. From the viewpoint that luster is easily reduced, and from the viewpoint that excellent combability is easily obtained, it is preferable that the aromatic vinyl compound includes styrene.

The content of the monomer unit of the aromatic vinyl compound (for example, the content of the monomer unit of styrene) in the maleic acid-based polymer may be 40% to 60% by mass or 45% to 55% by mass based on the total mass of the maleic acid-based polymer.

Examples of the maleimide compound include maleimide; N-alkylmaleimides such as N-methylmaleimide, N-butylmaleimide, and N-cyclohexylmaleimide; and aromatic maleimides such as N-phenylmaleimide, N-chlorophenylmaleimide, N-methylphenylmaleimide, N-methoxyphenylmaleimide, and N-tribromophenylmaleimide. From the viewpoint that luster is easily reduced, and from the viewpoint that excellent combability is easily obtained, it is preferable that the maleimide compound includes maleimide.

The content of the monomer unit of the maleimide compound (for example, the content of the monomer unit of maleimide) in the maleic acid-based polymer may be 35% to 50% by mass or 37% to 45% by mass based on the total mass of the maleic acid-based polymer.

Specific examples of the maleic acid-based polymer include a styrene-maleic anhydride copolymer; a maleic anhydride-modified polyalkylene (for example, maleic anhydride-modified polypropylene); a maleic anhydride-graft polymer; and terpolymers such as a styrene-maleimide-maleic anhydride copolymer, an ethylene-acrylic acid ester-maleic anhydride copolymer, and an ethylene-vinyl acetate-maleic anhydride copolymer. From the viewpoint that luster is easily reduced, and from the viewpoint that excellent combability is easily obtained, it is preferable that the maleic acid-based polymer includes a styrene-maleimide-maleic anhydride copolymer.

It is preferable that the content of the maleic acid-based polymer is in the following range based on the total mass of the fiber for artificial hair. From the viewpoint that luster is easily reduced, the content of the maleic acid-based polymer is preferably 0.1% by mass or more, more preferably 0.3% by mass or more, even more preferably 0.5% by mass or more, particularly preferably 1% by mass or more, extremely preferably 3% by mass or more, highly preferably 4% by mass or more, still more preferably, 5% by mass or more, even more preferably 7% by mass or more, particularly preferably 8% by mass or more, extremely preferably 9% by mass or more, highly preferably 10% by mass or more, still more preferably 15% by mass or more, even more preferably 20% by mass or more, particularly preferably 25% by mass or more, extremely preferably 30% by mass or more, and highly preferably 35% by mass or more. From the viewpoint that excellent combability and spinnability are easily obtained, the content of the maleic acid-based polymer is preferably 50% by mass or less, more preferably less than 50% by mass, even more preferably 45% by mass or less, particularly preferably 40% by mass or less, extremely preferably 35% by mass or less, highly preferably 30% by mass or less, still more preferably 25% by mass or less, even more preferably 20% by mass or less, particularly preferably 15% by mass or less, extremely preferably 10% by mass or less, highly preferably 9% by mass or less, still more preferably 8% by mass or less, even more preferably 7% by mass or less, particularly preferably 5% by mass or less, extremely preferably by mass or less, highly preferably 3% by mass or less, still more preferably 1% by mass or less, and even more preferably 0.5% by mass or less. From these viewpoints, the content of the maleic acid-based polymer is preferably 0.1% to 50% by mass.

It is preferable that the content of the maleic acid-based polymer is in the following range based on the total amount of the polyamide-based resin and the maleic acid-based polymer. From the viewpoint that luster is easily reduced, the content of the maleic acid-based polymer is preferably 0.1% by mass or more, more preferably 0.5% by mass or more, even more preferably 1% by mass or more, particularly preferably 3% by mass or more, extremely preferably 5% by mass or more, highly preferably 8% by mass or more, still more preferably 10% by mass or more, even more preferably 15% by mass or more, particularly preferably 20% by mass or more, extremely preferably 25% by mass or more, highly preferably 30% by mass or more, still more preferably 35% by mass or more, even more preferably 40% by mass or more, particularly preferably 45% by mass or more, and extremely preferably 50% by mass or more. From the viewpoint that excellent combability and spinnability are easily obtained, the content of the maleic acid-based polymer is preferably 90% by mass or less, more preferably 80% by mass or less, even more preferably 70% by mass or less, particularly preferably 60% by mass or less, extremely preferably 50% by mass or less, highly preferably less than 50% by mass, still more preferably 45% by mass or less, even more preferably 40% by mass or less, particularly preferably 35% by mass or less, extremely preferably 30% by mass or less, highly preferably 25% by mass or less, still more preferably 20% by mass or less, even more preferably 15% by mass or less, particularly preferably 10% by mass or less, extremely preferably 8% by mass or less, highly preferably 5% by mass of less, still more preferably 3% by, mass or less, even more preferably 1% by mass or less, and particularly preferably 0.5% by mass or less. From these viewpoints, the content of the maleic acid-based polymer is preferably 0.1% to 90% by mass.

The fiber for artificial hair of the present embodiment may contain aggregates of a maleic acid-based polymer. In the fiber for artificial hair of the present embodiment, it is preferable that in a cross-section parallel to the fiber axis direction of the fiber for artificial hair, aggregates of the maleic acid-based polymer are dispersed in the form of islets in the polyimide-based resin. In this case, as surface unevenness is likely to be suitably formed on the surface of the fiber, luster is likely to be reduced.

It is preferable that the average length of the aggregates of the maleic acid-based polymer in the fiber axis direction of the fiber for artificial hair is in the following range. From the viewpoint that luster is easily reduced, the average length of the aggregates is preferably 0.01 μm or more, more preferably 0.03 μm or more, even more preferably 0.05 μm or more, particularly preferably 0.07 μm or more, extremely preferably 0.1 μm or more, highly preferably 0.2 μm or more, still more preferably 0.3 μm or more, even more preferably 0.4 μm or more, particularly preferably 0.5 μm or more, extremely preferably 0.6 μm or more, highly preferably 0.8 μm or more, and still more preferably 1.0 μm or more. From the viewpoint that excellent combability and spinnability are easily obtained, the average length of the aggregates is preferably 10 μm or less, more preferably 8.0 μm or less, even more preferably 6.0 μm or less, particularly preferably 5.5 μm or less, extremely preferably 5.0 μm or less, highly preferably 4.0 μm or less, still more preferably 3.0 μm or less, even more preferably 2.0 μm or less, particularly preferably 1.0 μm or less, extremely preferably 0.8 μm or less, highly preferably 0.6 μm or less, still more preferably 0.5 μm or less, even more preferably 0.4 μm or less, particularly preferably 0.3 μm or less, extremely preferably 0.2 μm or less, and highly preferably 0.1 μm or less. From these viewpoints, the average length of the aggregates is preferably 0.01 to 10 μm. The average length of the aggregates may be 2.0 μm or more, 3.0 μm or more, 4.0 μm or more, 5.0 μm or more, or 5.5 μm or more. The average length of the aggregates may be 0.07 μm or less or 0.05 μm or less. The average length of the aggregates can be measured by the method described in the Examples that will be described below. The average length of the aggregates may be the average length of the aggregates of the fiber for artificial hair after a stretching treatment. The average length of the aggregates can be adjusted by means of the type and the use amount of the maleic acid-based polymer, and the like.

The fiber for artificial hair of the present embodiment may contain an additive other than the polyamide-based resin and the maleic acid-based polymer. Examples oldie additive include a flame retardant, a flame retardant aid, a colorant (a pigment, a dye, or the like), fine particles, a heat-resistant agent, a light stabilizer, a fluorescent agent, an oxidation inhibitor, an antistatic agent, a plasticizer, and a lubricating agent. The fiber for artificial hair of the present embodiment may not contain a polyester.

From the viewpoint that luster is easily reduced, and from the viewpoint that excellent combability is easily obtained, it is preferable that the flame retardant includes a bromine-based flame retardant (flame retardant containing a bromine atom). The content of the flame retardant is preferably 3 to 30 parts by mass, more preferably 5 to 25 parts by mass, and even more preferably 10 to 25 parts by mass, with respect to 100 parts by mass of the total amount of the polyamide-based resin and the maleic acid-based polymer. Furthermore, the content of the flame retardant may be more than 30 parts by mass with respect to 100 parts by mass of the polyamide-based resin.

Examples of the bromine-based flame retardant include a brominated phenol condensation product, a brominated polystyrene resin, a brominated benzyl acrylate-based flame retardant, a brominated epoxy resin, a brominated phenoxy resin (excluding components corresponding to the brominated epoxy resin), a brominated polycarbonate resin, and a bromine-containing triazine-based compound. From the viewpoint that luster is easily reduced, and from the viewpoint that excellent combability is easily obtained, it is preferable that the flame retardant includes a compound having a structure represented by the Formula (1) below (bromine-based flame retardant), and it is more preferable that the flame retardant includes a brominated epoxy resin having a structure represented by the Formula (1) below. When the fiber for artificial hair of the present embodiment contains a compound having a structure represented by Formula (1), from the viewpoint that an enhancement of the dispersibility of the flame retardant can be promoted, it is preferable that the maleic acid-based polymer has an aromatic vinyl compound (for example, styrene) as a monomer unit. As the aromatic vinyl compound, the above-mentioned styrene-based compound and the like in relation to the compound different from the maleic acid compound can be used.

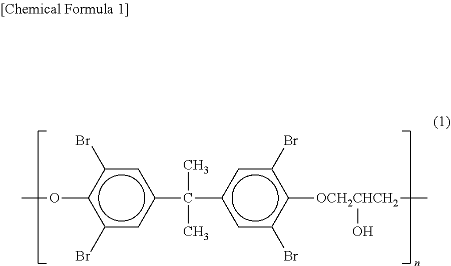

[n represents an integer of 1 or greater.]

A method for producing a fiber for artificial hair of the present embodiment includes a spinning step of spinning a composition containing a polyamide-based resin and a maleic acid-based polymer having at least one maleic acid compound selected from the group consisting of maleic acid and a maleic acid derivative as a monomer unit. According to the method for producing a fiber for artificial hair of the present embodiment, the fiber for artificial hair of the present embodiment can be obtained.

In the spinning step, a fiber containing the polyamide-based resin and the maleic acid-based polymer can be obtained. In the spinning step, a composition containing the polyamide-based resin and the maleic acid-based polymer can be subjected to melt-spinning (melt-deformation).

The melt viscosity of the polyamide-based resin as measured at 270° C. at a shear rate of 2400 [1/s] is preferably in the following range. From the viewpoint that luster is easily reduced, and from the viewpoint that excellent combability is easily obtained, the melt viscosity of the polyamide-based resin is preferably 50 Pa·s or more, more preferably 60 Pa·s or more, even more preferably 70 Pa·s or more, and particularly preferably 80 Pa·s or more. From the viewpoint that luster is easily reduced, and from the viewpoint that excellent combability is easily obtained, the melt viscosity of the polyamide-based resin is preferably 300 Pa·s or less, more preferably 250 Pa·s or less, even more preferably 200 Pa·s or less, particularly preferably 150 Pa·s or less, extremely preferably 120 Pa·s or less, highly preferably 110 Pa·s or less, and still more preferably 105 Pa·s or less. From these viewpoints, the melt viscosity of the poly-amide-based resin is preferably 50 to 300 Pa·s. The melt viscosity of the polyamide-based resin may be 90 Pa·s or more or 100 Pa·s or more. The melt viscosity of the polyamide-based resin may be 100 Pa·s or less, 90 Pa·s or less, or 80 Pa·s or less.

The melt viscosity of the maleic acid-based polymer as measured at 270° C. and a shear rate of 2400 [1/s] is preferably in the following range. From the viewpoint that luster is easily reduced, the melt viscosity of the maleic acid-based polymer is preferably 50 Pa·s or more, more preferably 100 Pa·s or more, even more preferably 300 Pa·s or more, particularly preferably 500 Pa·s or more, extremely preferably 600 Pa·s or more, and highly preferably 650 Pa·s or more. From the viewpoint that luster is easily reduced, and from the viewpoint that excellent combability is easily obtained, the melt viscosity of the maleic acid-based polymer is preferably 1000 Pa·s or less, more preferably 900 Pa·s or less, even more preferably 800 Pa·s or less, particularly preferably 700 Pa·s or less, extremely preferably 680 Pa·s or less, and highly preferably 650 Pa·s or less. From these viewpoints, the melt viscosity of the maleic acid-based polymer is preferably 50 to 1000 Pa·s, and more preferably 500 to 1000 Pa·s. The melt viscosity of the maleic acid-based polymer may be 680 Pa·s or more. The melt viscosity of the maleic acid-based polymer may be 600 Pa·s or less, 500 Pa·s or less, 300 Pa·s or less, or 100 Pa·s or less.

It is preferable that the difference (absolute value) between the melt viscosity of the polyamide-based resin as measured at 270° C. and a shear rate of 2400 [1/s] and the melt viscosity of the maleic acid-based polymer as measured at 270° C. and a shear rate of 2400 [1/s] is in the following range. From the viewpoint that luster is easily reduced because surface unevenness is particularly suitably formed on the surface of the fiber, the difference in the melt viscosity is preferably 20 Pa·s or more, more preferably 50 Pa·s or more, even more preferably 100 Pa·s or more, particularly preferably 200 Pa·s or more, extremely preferably 300 Pa·s or more, highly preferably 500 Pa·s or more, and still more preferably 540 Pa·s or more. From the viewpoint that luster is easily reduced, and from the viewpoint that excellent combability is easily obtained, the difference in the melt viscosity is preferably 900 Pa·s or less, more preferably 800 Pa·s or less, even more preferably 700 Pa·s or less, and particularly preferably 650 Pa·s or less. From these viewpoints, the difference in the melt viscosity is preferably 20 to 900 Pa·s. The difference in the melt viscosity may be 550 Pa·s or more, 590 Pa·s or more, 600 Pa·s or more, or 610 Pa·s or more. The difference in the melt viscosity may be 610 Pa·s or less, 600 Pa·s or less, 590 Pa·s or less, 550 Pa·s or less, 500 Pa·s or less, 300 Pa·s or less, 100 Pa·s or less, or 50 Pa·s or less.

The method for producing a fiber for artificial hair of the present embodiment may include a mixing step of mixing the polyamide-based resin and the maleic acid-based polymer to obtain a composition, before the spinning step. In the mixing step, it is preferable that the melt viscosity of at least one selected from the group consisting of the polyamide-based resin and the maleic acid-based polymer is in the above-mentioned range, and it is preferable that the difference between the melt viscosity of the polyamide-based resin and the melt viscosity of the maleic acid-based polymer is in the above-mentioned range.

The method for producing a fiber for artificial hair of the present embodiment may include a kneading step of melt-kneading a composition containing the polyamide-based resin and the maleic acid-based polymer, before the spinning step. As an apparatus for performing melt-kneading, various general kneading machines can be used. Examples of the kneading machine include a single-screw extruder, a twin-screw extruder, a roll, a Banbury mixer, and a kneader.

The method for producing a fiber for artificial hair of the present embodiment may include a stretching step of subjecting the fiber (unstretched fiber) obtained in the spinning step to a stretching treatment, after the spinning step.

From the viewpoint that the strength development of the fiber is likely to occur, the stretch ratio in the stretching step is preferably 1.5 times or more, and more preferably 2.0 times or more. From the viewpoint that fiber breakage is less likely to occur at the time of the stretching treatment, the stretch ratio is preferably 5.0 times or less, and more preferably 4.0 times or less. From these viewpoints, the stretch ratio is preferably 1.5 to 5.0 times, and more preferably 2.0 to 4.0 times.

The stretching treatment may be carried out by a two-step method in which an unstretched fiber is first wound on a bobbin and then stretched in a step that is not continuous with the spinning step, or may be carried out by a direct spinning stretching method in which an unstretched fiber is stretched in a step continuous with the spinning step without being wound on a bobbin. The stretching treatment may be carried out by a one-stage stretching method of performing stretching once to a desired stretch ratio or may be carried out by a multistage stretching method of performing stretching to a desired stretch ratio by two or more times of stretching.

The temperature of the stretching treatment is preferably 90° C. to 120° C. When the temperature is 90° C. or higher, the strength of the fiber is likely to be sufficiently secured and fiber breakage is less likely to occur. When the temperature is 120° C. or lower, a suitable tactile sensation of the fiber is likely to be obtained.

The method for producing a fiber for artificial hair of the present embodiment may include a heat treatment step of heat-treating (annealing) the fiber (stretched fiber) obtained in the stretching step, after the stretching step. By performing the heat treatment step, the thermal shrinkage rate of the stretched fiber can be decreased.

The heat treatment temperature is preferably 150° C. or higher, more preferably 160° C. or higher, even more preferably 170° C. or higher, and particularly preferably 180° C. or higher. The heat treatment temperature is preferably 200° C. or lower. The heat treatment may be carried out continuously after the stretching treatment or may be carried out after a while after winding the stretched fiber once.

A headdress article of the present embodiment includes the fiber for artificial hair of the present embodiment. The headdress article of the present embodiment is an article that is wearable on and removable from the head portion, and the headdress article may be an embodiment composed of the fiber for artificial hair of the present embodiment (for example, a fiber bundle of the fiber for artificial hair). Examples of the headdress article include a hairpiece, a hair wig, and false hair.

### EXAMPLES

Hereinafter, the present invention will be specifically described by way of Examples and Comparative Examples; however, the present invention is not intended to be limited to these Examples.

### Production of Unstretched Fiber

A polyamide-based resin was dried to adjust the water absorption rate to 1000 ppm or less. The polyamide-based resin, the maleic acid-based polymer, and other additives shown in Table 1 and Table 2 were mixed to obtain a mixture (unit of the blending amounts in Table 1 and Table 2: parts by mass).

The details of each of the materials used in Examples and Comparative Examples are as follows. The content of maleic anhydride means the content of a monomer unit of maleic anhydride in the maleic acid-based polymer.

### Polyamide-Based Resin

Polyamide resin A. Mixture of polyamide A1 (polyamide 66, manufactured b Ube Industries, Ltd., trade name “1013B”, melt viscosity 80 Pa·s (measured at 270° C. and a shear rate of 2400 [1/s])) and polyamide A2 (polyamide 66, manufactured by Ube Industries, Ltd., trade name “1022B”, melt viscosity 187 Pa·s (measured at 270° C. and a shear rate of 2400 [1/s])) (mass ratio, A1:A2=65:35)

Polyamide resin B: Polyamide 66 manufactured by Ube Industries, Ltd., trade name “1013B”, melt viscosity 80 Pa·s (measured at 270° C. and a shear rate of 2400 [1/s])

Polyamide resin C: Polyamide 66, manufactured by Asahi Kasei Corp., trade name “LEONA 1300 301”

### Maleic Acid-Based Polymer

Polymer A: Styrene-maleimide-maleic anhydride copolymer, manufactured by Denka Company Limited, trade name “MS-NB”, melt viscosity 696 Pa·s (measured at 270° C. and a shear rate of 2400 [1/s]), content of maleic anhydride 1.5% by mass

Polymer B: Styrene-maleimide-maleic anhydride copolymer, in-house manufactured product, melt viscosity 650 Pa·s (measured at 270° C. and a shear rate of 2400 [1/s]), content of maleic anhydride 0.5% by mass

Polymer C: Modified SEBS (maleic anhydride-modification product of a styrene-ethylene/butylene-styrene block copolymer), manufactured by Asahi Kasei Corp., trade name “TUFTEC M1913”, melt viscosity 79 Pa·s (measured at 270° C. and a shear rate of 2400 [1/s]), content of maleic anhydride 1.5% by mass

Polymer D: Styrene-maleimide-maleic anhydride copolymer, manufactured by Denka Company Limited, trade name “MS-L2A”, melt viscosity 944 Pa·s (measured at 270° C. and a shear rate of 2400 [1/s]), content of maleic anhydride 6.0% by mass

Polymer E: Maleic anhydride-modified polypropylene, manufactured by Sanyo Chemical Industries, Ltd., trade name “UMEX 1010”, melt viscosity 10 Pa·s (measured at 270° C. and a shear rate of 2400 [1/s])

Polymer F: Maleic anhydride-modified polypropylene, manufactured by Sanyo Chemical Industries, Ltd., trade name “UMEX 1001”, melt viscosity 12 Pa·s measured at 270° C. and a shear rate of 2400 [1/s])

Polymer G: Maleic anhydride-modified polypropylene, manufactured by RIKEN VITAMIN CO., LTD., trade name “RIKEAID MG-670P”, melt viscosity 2.5 Pa·s (measured at 270° C. and a shear rate of 2400 [1/s])

Polymer H: Maleic anhydride-modified polypropylene, manufactured by RIKEN VITAMIN CO., LTD., trade name “RIKEAID MG-400P”, melt viscosity 2.2 Pa·s (measured at 270° C. and a shear rate of 2400 [1/s])

Polymer I: Maleic anhydride-modified polypropylene, manufactured by RIKEN VITAMIN CO., LTD., trade name “RIKEAID MG-250P”, melt viscosity 1.6 Pa·s (measured at 270° C. and a shear rate of 2400 [1/s])

### Other Additives

Flame retardant: Brominated epoxy resin, manufactured by Sakamoto Yakuhin Kogyo Co., Ltd., trade name “SRT-20000”

Flame retardant aid: Manufactured by Suzuhiro Chemical Co., Ltd., trade name “S-370DE”

Colorant A: Manufactured by Saika Color Co., Ltd., trade name “SPUNDYE NGS BK-35”

Colorant B: Manufactured by Saika Color Co., Ltd., trade name “PA-7-4089 RED”

Colorant C: Manufactured by Saika Color Co., Ltd., trade name “PA7-4092 YELLOW”

Oxidation inhibitor A: Manufactured by BASF Japan, Ltd., trade name “IRGANOX 1098”

Oxidation inhibitor B: Manufactured by BASF Japan, Ltd., trade name “IRGAFOS 168”

Lubricating agent: Manufactured by Nitta Chemical Industry Co., Ltd., trade name “CS-8CP”

The above-mentioned mixture was kneaded using a ϕ30-mm twin-screw extruder, and a raw material pellet for spinning was obtained. Next, the raw material pellet was dried to adjust the water absorption rate to 1000 ppm or less. Subsequently, the raw material pellet was melt-kneaded at a barrel setting temperature of 280° C. by using a ϕ40-mm twin-screw extruder. Then, the discharge amount was adjusted to be constant by a gear pump, melt-spinning was then performed in a vertical direction through a die with a hole diameter of 0.5 mm/hole at a temperature of 295° C., and an unstretched fiber (unstretched fiber for artificial hair) was wound at a constant speed by a take-over machine provided at a position 2 m right below the nozzles. The single fiber fineness of the unstretched fiber was 145 decitex.

### Measurement of Spinnability

For the above-mentioned unstretched fibers of Examples 1 to 28 and Comparative Example 1, the number of fiber breakages per 200 fibers of unstretched fiber (the length of one fiber is 3000 m) was measured by visual inspection. The results are shown in Table 1 and Table 2. It is more preferable as the number of fiber breakages is smaller.

### Production of Fiber for Evaluation

An unstretched fiber was stretched at 100° C. and then was subjected to annealing at 180° C., and a fiber for evaluation (fiber for artificial hair after stretching) having a single fiber fineness of 66 decitex was obtained. The stretch ratio was 2.3 times, and the relaxation ratio during annealing was 6.8%. The relaxation ratio during annealing is a value calculated by the formula: “(speed of rotation of a drawing roller during annealing)/(speed of rotation of a feeding roller during annealing)”.

### Observation of Cross-Section in Fiber for Evaluation

An observation of a cross-section in the above-mentioned fibers for evaluation of Examples 1 to 28 was conducted. First, a fiber for evaluation was embedded in an epoxy resin and then was subjected to RuO₄ staining. Next, a cross-section parallel to the fiber axis direction in the fiber for evaluation was exposed with a cryomicrotome, and then a plasma etching treatment and an electrical conduction treatment (Os coating treatment) were carried out. Subsequently, the cross-section was observed at an accelerating voltage of 1.2 kV by using a field emission type scanning electron microscope (FE-SEM, manufactured by Carl Zeiss AG, trade name “MERLIN”) to obtain images. For the fibers for evaluation of Examples 1 to 10 and 12 to 28, it was observed that aggregates of a maleic acid-based polymer were dispersed in the form of islets in a poly amide-based resin.

For the above-mentioned fibers for evaluation of Examples 1 to 10 and 12 to 13, the average length in the fiber axis direction of the aggregates of the maleic acid-based polymer was measured using the images obtained by the above-described cross-sectional observation. Twenty aggregates of the maleic acid-based polymer were arbitrarily selected from the images, and the average length in the fiber axis direction was calculated. The results are shown in Table 1.

### Evaluation of Fiber for Evaluation

Luster and combability were evaluated using the above-mentioned fibers for evaluation. Combability was evaluated for Examples 1 to 13 and Comparative Example 1. The details of each evaluation are as follows. The measurement results are shown in Table 1 and Table 2.

### Luster

An evaluation of luster as performed by measuring the degree of luster. For the measurement of the degree of luster, a variable angle photometer (goniophotometer) GP-700 manufactured by Murakami Color Research Laboratory was used. First, a reference fiber (manufactured by Denka Company Limited, polyamide-based fiber for artificial hair Luxeena, hue #613T) was placed on a sample stand, the sensitivity adjustment dial value (COARSE) was set to 718, the sensitivity adjustment dial value (FINE) was set to 737, the incident angle was set to 45°, and the intensity of the incident light, the gain of the detector, and the like were adjusted such that the intensity of reflected light at an acceptance angle of 45° was 80% of the detection limit of the apparatus. Thereafter, the above-mentioned fiber for evaluation was placed on a sample stand, and the intensity of reflected light was measured by varying the acceptance angle from 10° to 80°. Then, the maximum value of the intensity of reflected light with respect to the detection limit of the apparatus was obtained as the degree of luster [unit: %]. A case where the degree of luster was 90% or less was considered to be satisfactory.

### Combability

The evaluation of combability was carried out by measuring the resistance three when the above-mentioned fiber for evaluation was combed. Specifically, the resistance force [unit: gf] obtained when combing the fiber for evaluation having a length of 30 cm and a mass of 20 g at a moving speed of 10 mm/sec and a moving distance of 100 mm as measured with a static/dynamic friction measuring machine (manufactured by Trinity-Lab, Inc., trade name “TL201Tt”). It is more preferable as the resistance force is smaller.

TABLE 1

| | | Example | | | | | | | |
|---|---|---|---|---|---|---|---|---|---|
| | | 1 | 2 | 3 | 4 | 5 | 6 | 7 | 8 |
| Polyamide- | Polyamide resin A | 99.5 | 95 | 90 | 80 | — | — | 50 | 90 |
| based resin | Polyamide resin B | — | — | — | — | 65 | 60 | — | — |
| | Melt viscosity [Pa · s] | 102 | 102 | 102 | 102 | 80 | 80 | 102 | 102 |
| Maleic | Polymer A | 0.5 | 5 | 10 | 20 | 35 | 40 | 50 | 10 |
| acid-based | Polymer B | — | — | — | — | — | — | — | — |
| polymer | Polymer C | — | — | — | — | — | — | — | — |
| | Melt viscosity [Pa · s] | 696 | 696 | 696 | 696 | 696 | 696 | 696 | 696 |
| | Difference in melt | 594 | 594 | 594 | 594 | 616 | 616 | 594 | 594 |
| | viscosity [Pa · s] (vs | | | | | | | | |
| | polyamide-based resin) | | | | | | | | |
| | Content of maleic | 1.5 | 1.5 | 1.5 | 1.5 | 1.5 | 1.5 | 1.5 | 1.5 |
| | anhydride [mass %] | | | | | | | | |
| | Aggregate average | 0.1 | 0.2 | 0.2 | 0.3 | 0.4 | 0.6 | 1.0 | 0.2 |
| | length [μm] | | | | | | | | |
| Flame retardant | | 25 | 25 | 25 | 25 | 25 | 25 | 25 | — |
| Flame retardant aid | | 2.1 | 2.1 | 2.1 | 2.1 | 2.1 | 2.1 | 2.1 | — |
| Colorant | Colorant A | 1.4 | 1.4 | 1.4 | 1.4 | 1.4 | 1.4 | 1.4 | 1.4 |
| | Colorant B | 0.6 | 0.6 | 0.6 | 0.6 | 0.6 | 0.6 | 0.6 | 0.6 |
| | Colorant C | 0.2 | 0.2 | 0.2 | 0.2 | 0.2 | 0.2 | 0.2 | 0.2 |
| Spinnability | Number of fiber | 0 | 0 | 0 | 0 | 0 | 0 | 0 | 0 |
| | breakages [fibers] | | | | | | | | |
| Luster | Degree of luster [%] | 70 | 57 | 49 | 48 | 33 | 33 | 31 | 48 |
| Combability | Resistance force | 44 | 45 | 48 | 49 | 52 | 54 | 63 | 50 |
| | upon combing [gf] | | | | | | | | |

| | | | | | | | Comparative |
|---|---|---|---|---|---|---|---|
| | | Example | | | | | Example |
| | | 9 | 10 | 11 | 12 | 13 | 1 |
| Polyamide- | Polyamide resin A | 90 | 80 | 99.5 | 90 | 80 | 100 |
| based resin | Polyamide resin B | — | — | — | — | — | — |
| | Melt viscosity [Pa · s] | 102 | 102 | 102 | 102 | 102 | 102 |
| Maleic | Polymer A | — | — | — | — | — | — |
| acid-based | Polymer B | 10 | 20 | — | — | — | — |
| polymer | Polymer C | — | — | 0.5 | 10 | 20 | — |
| | Melt viscosity [Pa · s] | 650 | 650 | 79 | 79 | 79 | — |
| | Difference in melt | 548 | 548 | 23 | 23 | 23 | — |
| | viscosity [Pa · s] (vs | | | | | | |
| | polyamide-based resin) | | | | | | |
| | Content of maleic | 0.5 | 0.5 | 1.5 | 1.5 | 1.5 | — |
| | anhydride [mass %] | | | | | | |
| | Aggregate average | 4.0 | 5.5 | ND | 0.05 | 0.07 | — |
| | length [μm] | | | | | | |
| Flame retardant | | 25 | 25 | 25 | 25 | 25 | 25 |
| Flame retardant aid | | 2.1 | 2.1 | 2.1 | 2.1 | 2.1 | 2.1 |
| Colorant | Colorant A | 1.4 | 1.4 | 1.4 | 1.4 | 1.4 | 1.4 |
| | Colorant B | 0.6 | 0.6 | 0.6 | 0.6 | 0.6 | 0.6 |
| | Colorant C | 0.2 | 0.2 | 0.2 | 0.2 | 0.2 | 0.2 |
| Spinnability | Number of fiber | 2 | 4 | 0 | 0 | 0 | 0 |
| | breakages [fibers] | | | | | | |
| Luster | Degree of luster [%] | 35 | 32 | 86 | 80 | 74 | 96 |
| Combability | Resistance force | 82 | 88 | 42 | 44 | 46 | 42 |
| | upon combing [gf] | | | | | | |

TABLE 2

| | | Example | | | | | | | | |
|---|---|---|---|---|---|---|---|---|---|---|
| | | 14 | 15 | 16 | 17 | 18 | 19 | 20 | 21 | 22 |
| Polyamide- | Polyamide resin C | 97.5 | 95 | 90 | 97.5 | 95 | 92.5 | 97.5 | 95 | 95 |
| based resin | | | | | | | | | | |
| Maleic | Polymer A | 2.5 | 5 | 10 | — | — | — | — | — | — |
| acid-based | Polymer D | — | — | — | 2.5 | 5 | 7.5 | — | — | — |
| polymer | Polymer E | — | — | — | — | — | — | 2.5 | 5 | — |
| | Polymer F | — | — | — | — | — | — | — | — | 5 |
| | Polymer G | — | — | — | — | — | — | — | — | — |
| | Polymer H | — | — | — | — | — | — | — | — | — |
| | Polymer I | — | — | — | — | — | — | — | — | — |
| Flame retardant | | 27.5 | 27.5 | 27.5 | 27.5 | 27.5 | 27.5 | 27.5 | 27.5 | 27.5 |
| Flame retardant aid | | 2.3 | 2.3 | 2.3 | 2.3 | 2.3 | 2.3 | 2.3 | 2.3 | 2.3 |
| Colorant | Colorant A | 1.4 | 1.4 | 1.4 | 1.4 | 1.4 | 1.4 | 1.4 | 1.4 | 1.4 |
| | Colorant B | 0.6 | 0.6 | 0.6 | 0.6 | 0.6 | 0.6 | 0.6 | 0.6 | 0.6 |
| | Colorant C | 0.2 | 0.2 | 0.2 | 0.2 | 0.2 | 0.2 | 0.2 | 0.2 | 0.2 |
| Oxidation | Oxidation inhibitor A | 0.2 | 0.2 | 0.2 | 0.2 | 0.2 | 0.2 | 0.2 | 0.2 | 0.2 |
| inhibitor | Oxidation inhibitor B | 0.2 | 0.2 | 0.2 | 0.2 | 0.2 | 0.2 | 0.2 | 0.2 | 0.2 |
| Lubricating agent | | 1.1 | 1.1 | 1.1 | 1.1 | 1.1 | 1.1 | 1.1 | 1.1 | 1.1 |
| Spinnability | Number of fiber | 0 | 0 | 0 | 0 | 0 | 0 | 0 | 0 | 0 |
| | breakages [fibers] | | | | | | | | | |
| Luster | Degree of luster [%] | 30 | 29 | 25 | 30 | 26 | 24 | 39 | 36 | 37 |

| | | | | | | | | Comparative |
|---|---|---|---|---|---|---|---|---|
| | | Example | | | | | | Example |
| | | 23 | 24 | 25 | 26 | 27 | 28 | 2 |
| Polyamide- | Polyamide resin C | 90 | 90 | 97 | 94 | 96 | 92 | 100 |
| based resin | | | | | | | | |
| Maleic | Polymer A | — | — | — | — | — | — | — |
| acid-based | Polymer D | — | — | — | — | — | — | — |
| polymer | Polymer E | — | — | — | — | — | — | — |
| | Polymer F | 10 | — | — | — | — | — | — |
| | Polymer G | — | 10 | — | — | — | — | — |
| | Polymer H | — | — | 3 | 6 | — | — | — |
| | Polymer I | — | — | — | — | 4 | 8 | — |
| Flame retardant | | 27.5 | 27.5 | 27.5 | 27.5 | 27.5 | 27.5 | 27.5 |
| Flame retardant aid | | 2.3 | 2.3 | 2.3 | 2.3 | 2.3 | 2.3 | 2.3 |
| Colorant | Colorant A | 1.4 | 1.4 | 1.4 | 1.4 | 1.4 | 1.4 | 1.4 |
| | Colorant B | 0.6 | 0.6 | 0.6 | 0.6 | 0.6 | 0.6 | 0.6 |
| | Colorant C | 0.2 | 0.2 | 0.2 | 0.2 | 0.2 | 0.2 | 0.2 |
| Oxidation | Oxidation inhibitor A | 0.2 | 0.2 | 0.2 | 0.2 | 0.2 | 0.2 | 0.2 |
| inhibitor | Oxidation inhibitor B | 0.2 | 0.2 | 0.2 | 0.2 | 0.2 | 0.2 | 0.2 |
| Lubricating agent | | 1.1 | 1.1 | 1.1 | 1.1 | 1.1 | 1.1 | 1.1 |
| Spinnability | Number of fiber | 0 | 0 | 0 | 0 | 0 | 0 | — |
| | breakages [fibers] | | | | | | | |
| Luster | Degree of luster [%] | 34 | 78 | 54 | 34 | 68 | 62 | 97 |

As shown in Table 1 and Table 2, it is found that a fiber for artificial hair with reduced luster can be achieved by using a polyamide-based resin and a maleic acid-based polymer in combination.

1. A fiber for artificial hair, comprising a polyamide-based resin and a maleic acid-based polymer having at least one maleic acid compound selected from the group consisting of maleic acid and a maleic acid derivative as a monomer unit.

2. The fiber for artificial hair according to claim 1, wherein in a cross-section parallel to a fiber axis direction of the fiber for artificial hair, aggregates of the maleic acid-based polymer are dispersed in the form of islets in the polyamide-based resin.

3. The fiber for artificial hair according to claim 2, wherein an average length of the aggregates in the fiber axis direction is 0.1 μm or more.

4. The fiber for artificial hair according to claim 1, wherein the maleic acid compound includes maleic anhydride.

5. The fiber for artificial hair according to claim 1, wherein a content of the monomer unit of the maleic acid compound is 1% by mass or more based on the total mass of the maleic acid-based polymer.

6. The fiber for artificial hair according to claim 1, wherein the maleic acid-based polymer includes a styrene-maleimide-maleic anhydride copolymer.

7. A headdress article comprising the fiber for artificial hair according to claim 1.

8. A method for producing a fiber for artificial hair, the method comprising a step of spinning a composition containing a polyamide-based resin and a maleic acid-based polymer having at least one maleic acid compound selected from the group consisting of maleic acid and a maleic acid derivative as a monomer unit.

9. The method for producing a fiber for artificial hair according to claim 8,
wherein a melt viscosity of the polyamide-based resin as measured at 270° C. and a shear rate of 2400 [1/s] is 50 to 300 Pa·s, and
a melt viscosity of the maleic acid-based polymer as measured at 270° C. and a shear rate of 2400 [1/s] is 500 to 1000 Pa·s.

10. The method for producing a fiber for artificial hair according to claim 8, wherein a difference between a melt viscosity of the polyamide-based resin as measured at 270° C. and a shear rate of 2400 [1/s] and a melt viscosity of the maleic acid-based polymer as measured at 270° C. and a shear rate of 2400 [1/s] is 200 Pa·s or more.

11. The fiber for artificial hair according to claim 1, wherein the maleic acid-based polymer further has an aromatic vinyl compound as a monomer unit.

12. The fiber for artificial hair according to claim 11, wherein a content of the monomer unit of the aromatic vinyl compound in the maleic acid-based polymer is 40% to 60% by mass on a total mass of the maleic acid-based polymer.

13. The fiber for artificial hair according to claim 1, wherein the maleic acid-based polymer further has a styrene-based compound as a monomer unit.

14. The fiber for artificial hair according to claim 1, wherein the maleic acid-based polymer further has styrene as a monomer unit.

15. The fiber for artificial hair according to claim 1, wherein the maleic acid-based polymer further has a maleimide compound as a monomer unit.

16. The fiber for artificial hair according to claim 15, wherein a content of the monomer unit of the maleimide compound in the maleic acid-based polymer is 35% to 50% by mass based on a total mass of the maleic acid-based polymer.

17. The fiber for artificial hair according to claim 1, wherein the maleic acid-based polymer further has maleimide as a monomer unit.

18. The fiber for artificial hair according to claim 1, wherein the fiber further comprises a compound having a structure represented by the Formula (1) below: 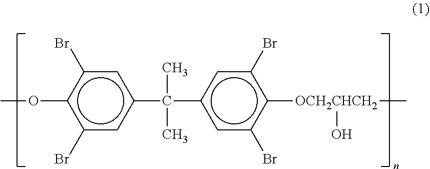
n represents an integer of 1 or greater.

19. The fiber for artificial hair according to claim 1, wherein the fiber does not comprise a polyester.
